(19) United States
(12) Patent Application Publication
(10) Pub. No.: US 2026/0126359 A1
(43) Pub. Date: May 7, 2026

(54) METHOD FOR DETERMINING FRACTURE TOUGHNESS OF CEMENTED CARBIDE

(71) Applicant: China Academy of Machinery Wuhan Research Institute of Materials Protection Co.,Ltd, Wuhan (CN)

(72) Inventors: Dan Jia, Wuhan (CN); Wenxuan Li, Wuhan (CN); Haitao Duan, Wuhan (CN); Jian Li, Wuhan (CN); Wulin Zhang, Wuhan (CN); Shengpeng Zhan, Wuhan (CN); Tian Yang, Wuhan (CN)

(21) Appl. No.: 19/366,579

(22) Filed: Oct. 23, 2025

(30) Foreign Application Priority Data
Nov. 6, 2024 (CN) 202411573041.X

(51) Int. Cl. G01N 3/08; C22C 29/06; G06F 30/23; G06F 119/14

(52) U.S. Cl. CPC G01N 3/08; C22C 29/06; G06F 30/23; G01N 2203/0017; G01N 2203/0067; G01N 2203/0075; G06F 2119/14

(57) ABSTRACT

A method for determining fracture toughness includes: obtaining an elastic modulus, a Poisson's ratio, and a stress-strain curve of a cemented carbide specimen; calculating, based on a fracture calculation formula, a maximum cohesive force; constructing a Mooney-Rivlin model and a cohesive force model in a finite element simulation software to describe characteristics of the cemented carbide specimen; constructing models of the cemented carbide specimen under different fracture modes in the finite element simulation software, and performing J-integral analysis to obtain mode I and mode II fracture energies; and performing a nanoindentation uniaxial compression finite element numerical simulation to obtain simulated values of stress-strain results, performing a nanoindentation experiment on the cemented carbide specimen to obtain experimental values of the stress-strain results, and adjusting parameters in finite element simulation analysis based on differences between the simulated values and the experimental values, and recalculating the mode I and mode II fracture energies.

### CROSS-REFERENCE TO RELATED APPLICATION

This application claims priority to Chinese Patent Application No. 202411573041.X, filed Nov. 6, 2024, which is herein incorporated by reference in its entirety.

### TECHNICAL FIELD

The disclosure relates to the field of cemented carbide (also referred to as hard alloy) performance testing, and more particularly to a method for determining fracture toughness of cemented carbide.

### BACKGROUND

In recent years, physical vapor deposited (PVD) cemented carbide coatings have shown great potential in improving surface properties and extending the service life of metal components due to their excellent thermal stability, mechanical properties, oxidation resistance, and corrosion resistance. However, the insufficient toughness of the cemented carbide coatings can lead to brittle spalling during friction, causing gradual wear and failure of metal components. The lack of strength and toughness severely limits the application of the cemented carbide coatings in extreme conditions such as marine, nuclear, and aerospace environments

Fracture toughness, as one of the main mechanical properties of cemented carbide materials, is an index that measures ability of a material to resist crack propagation in the presence of cracks or similar defects. This ability can be described by parameters such as energy release rate, stress intensity factor, crack tip opening displacement (CTOD), and J-integral. Materials with high fracture toughness can prevent or delay crack propagation when cracks occur, thereby enhancing the safety and reliability of structures. This is crucial for ensuring the safe operation of important engineering structures. Currently, the fracture toughness is generally measured through experiments. However, conventional fracture toughness testing involves complex steps, including sample preparation, fixture selection, displacement gauge connection, load application, crack size measurement, and fracture toughness calculation. Moreover, the test results are influenced by various factors such as cross-sectional dimensions, temperature, and strain rate.

Using the finite element method to determine the fracture toughness of cemented carbide coatings, relevant nanoindentation simulations have already established numerical models. However, conventional simulation can only calculate the elastic properties of the film, such as hardness and elastic modulus, from the load-displacement curve, and cannot provide information on the film performance, making it difficult to reasonably determine the fracture toughness parameters of the cemented carbide. Therefore, there are still significant issues in the fracture simulation of cemented carbide coatings.

### SUMMARY

The disclosure provides a method for determining fracture toughness of cemented carbide, including:
preparing a cemented carbide specimen, and performing a tensile mechanical experiment on the cemented carbide specimen to obtain an elastic modulus, a Poisson's ratio, and a stress-strain curve of the cemented carbide specimen;
selecting a stress-strain value at a fracture point on the stress-strain curve, and calculating, based on a fracture calculation formula and the stress-strain value, a maximum cohesive force;
constructing a Mooney-Rivlin model and a cohesive force model in a finite element simulation software to jointly describe characteristics of the cemented carbide specimen; using, when a crack has not formed in the cemented carbide specimen, the Mooney-Rivlin model as a main constitutive model to describe the characteristics of the cemented carbide specimen; and using, when the crack has formed in the cemented carbide specimen, the cohesive force model as the main constitutive model to describe the characteristics of the cemented carbide specimen;
importing the elastic modulus, the Poisson's ratio, and the stress-strain curve into the finite element simulation software, constructing models of the cemented carbide specimen under multiple different fracture modes in the finite element simulation software, and performing, based on the models of the cemented carbide specimen, J-integral analysis to obtain a mode I fracture energy and a mode II fracture energy; and
importing the mode I fracture energy and the mode II fracture energy into the cohesive force model, performing a nanoindentation uniaxial compression finite element numerical simulation in the finite element simulation software to obtain simulated values of stress-strain results, performing a nanoindentation experiment on the cemented carbide specimen to obtain experimental values of the stress-strain results, and adjusting parameters in finite element simulation analysis based on differences between the simulated values and the experimental values of the stress-strain results, and recalculating the mode I fracture energy and the mode II fracture energy.

In an embodiment, the method further includes: determining, based on the mode I fracture energy and the mode II fracture energy, crack propagation of the cemented carbide specimen, and determining, based on the crack propagation of the cemented carbide specimen, whether the cemented carbide specimen is qualified.

In an embodiment, the calculating, based on a fracture calculation formula and the stress-strain value, a maximum cohesive force includes:
calculating the maximum cohesive force Tₘₐₓ using the fracture calculation formula

$$t = \{ \begin{matrix}K δ , & δ ⩽ {δ}_{c} \\ {T}_{max} , & δ > {δ}_{c}\end{matrix} ,$$

where t represents a cohesive force, K represents a cohesive force stiffness, δ represents a crack tip opening displacement, and δ_{c} represents a critical displacement; and
dividing, during calculation of the maximum cohesive force, the cohesive force into a normal stress value σ and a shear stress value τ through control equations as follows:

$$σ = \{ \begin{matrix}\frac{{σ}_{max}}{{δ}_{n}^{0}} δ & δ ⩽ {δ}_{n}^{0} \\ {σ}_{max} \frac{{δ}_{n}^{f} - δ}{{δ}_{n}^{f} - {δ}_{n}^{0}} & δ > {δ}_{n}^{0}\end{matrix} ,$$

$$τ = \{ \begin{matrix}\frac{{τ}_{max}}{{δ}_{t}^{0}} δ & δ ⩽ {δ}_{t}^{0} \\ {τ}_{max} \frac{{δ}_{t}^{f} - δ}{{δ}_{t}^{f} - {δ}_{t}^{0}} & δ > {δ}_{t}^{0}\end{matrix} ;$$

where σₘₐₓ represents a maximum normal stress value, and

$${δ}_{n}^{0}$$

represents a crack interface opening displacement value corresponding to the maximum normal stress value; τₘₐₓ represents a maximum shear stress value, and

$${δ}_{t}^{0}$$

represents a crack interface opening displacement value corresponding to the maximum shear stress value, and

$${δ}_{n}^{f}$$

represents a crack interface opening displacement value corresponding to a stress value exceeding σₘₐₓ, and

$${δ}_{t}^{f}$$

represents a crack interface opening displacement value corresponding to a stress value exceeding τₘₐₓ.

In an embodiment, the constructing a Mooney-Rivlin model and a cohesive force model in a finite element simulation software to jointly describe characteristics of the cemented carbide specimen includes:
when the crack has not formed in the cemented carbide specimen, using the Mooney-Rivlin model as the main constitutive model for calculating the characteristics of the cemented carbide specimen, and describing a material stress-strain relationship through a strain energy density function:

$$W = {C}_{10} ( {I}_{1} - 3 ) + {C}_{01} ( {I}_{2} - 3 ) + \frac{1}{d} {( J - 1 )}^{2} ;$$

where C₁₀ and C₀₁ represent constants; d represents a stiffness that controls volumetric deformation, similar to the inverse of the bulk modulus; I₁ and I₂ respectively represent a first strain invariant and a second strain invariant of the Green deformation tensor; and J represents a volume ratio, which is the determinant of the deformation gradient, that is, a ratio of a current volume to an initial volume;
when the crack has formed in the cemented carbide specimen, using the cohesive force model as the main constitutive model for calculating the characteristics of the cemented carbide specimen, including; and assuming that there is a cohesive force zone at an interface of the crack (i.e., a crack propagation interface) or a crack tip of the crack, where a material stress-strain relationship in the cohesive force zone is different from that in other regions; defining a constitutive relationship and a damage evolution law of the cohesive force zone; and simulating debonding of the interface and propagation of the crack.

In an embodiment, the importing the elastic modulus, the Poisson's ratio, and the stress-strain curve into the finite element simulation software, constructing models of the cemented carbide specimen under multiple different fracture modes in the finite element simulation software, and performing, based on the models of the cemented carbide specimen, J-integral analysis to obtain a mode I fracture energy and a mode II fracture energy includes:
constructing, based on linear elastic fracture mechanics, micro-pillar models of the cemented carbide specimen for an opening mode, a sliding mode and a tearing mode, and calculating stress-strain results for opening-mode fracture, in-plane shear fracture, and transverse shear fracture by using the micro-pillar models, respectively;
determining, according to the stress-strain results for the opening-mode fracture, the in-plane shear fracture and the transverse shear fracture, stress angular variations for the micro-pillar models of the cemented carbide specimen for the opening mode, the sliding mode and the tearing mode;
importing the stress angular variations for the micro-pillar models of the cemented carbide specimen for the opening mode, the sliding mode and the tearing mode into a partial derivative equation of crack tip asymptotic solution to obtain a relationship among stress, angle and a distance from an integration point to the crack tip; and
performing, based on the relationship among the stress, the angle and the distance from the integration point to the crack tip, the J-integral analysis to obtain the mode I fracture energy and the mode II fracture energy.

In an embodiment, the performing a nanoindentation uniaxial compression finite element numerical simulation in the finite element simulation software to obtain simulated values of stress-strain results, performing a nanoindentation experiment on the cemented carbide specimen to obtain experimental values of the stress-strain results, and adjusting parameters in finite element simulation based on differences between the simulated values and the experimental values of the stress-strain results, and recalculating the mode I fracture energy and the mode II fracture energy includes:
performing the nanoindentation uniaxial compression finite element numerical simulation in the finite element simulation software on the models of the cemented carbide specimen to obtain the simulated values of the stress-strain results, performing the nanoindentation experiment on the cemented carbide specimen to obtain the experimental values of the stress-strain results, and adjusting, based on magnitudes of the simulated values and the experimental values of the stress-strain results, a mesh size and a mesh number in the finite element simulation software;
performing the nanoindentation uniaxial compression finite element numerical simulation in the finite element simulation software on the models of the cemented carbide specimen under different pressure conditions to obtain simulated values under different pressure conditions, performing the nanoindentation experiment on the cemented carbide specimen to obtain the experimental values of the stress-strain results, and adjusting uncertain parameters in the finite element simulation analysis based on differences between the simulated values under different pressure conditions and the experimental values of the stress-strain results; and
recalculating the mode I fracture energy and the mode II fracture energy.

In an embodiment, the performing the nanoindentation uniaxial compression finite element numerical simulation in the finite element simulation software on the models of the cemented carbide specimen to obtain the simulated values of the stress-strain results, performing the nanoindentation experiment on the cemented carbide specimen to obtain the experimental values of the stress-strain results, and adjusting, based on magnitudes of the simulated values and the experimental values of the stress-strain results, a mesh size and a mesh number in the finite element simulation software includes:
reducing the mesh size and decreasing the number of meshes when computation time is too long, i.e., when the computation time exceeds 24 hours;
refining a mesh in a fracture part, reducing the mesh size and increasing the mesh number when accuracy of simulation results is low (i.e., when the error between the calculation results and the actual test results exceeds 5%).

In an embodiment, the performing the nanoindentation uniaxial compression finite element numerical simulation in the finite element simulation software on the models of the cemented carbide specimen under different pressure conditions to obtain simulated values under different pressure conditions, performing the nanoindentation experiment on the cemented carbide specimen to obtain the experimental values of the stress-strain results, and adjusting uncertain parameters in the finite element simulation based on differences between the simulated values under different pressure conditions and the experimental values of the stress-strain results includes:
performing, when an error between the simulated values under different pressure conditions and the experimental values of the stress-strain results exceeds a threshold, uncertainty parameter impact analysis on the uncertain parameters in the finite element simulation to assess impact weights of the uncertain parameters on calculation results of the fracture toughness including crack propagation length and defect distribution, etc., where the uncertain parameters include material parameters of the cemented carbide specimen, geometric parameters of the cemented carbide specimen, and loading conditions in the finite element simulation software; and
adjusting, based on results of the uncertainty parameter impact analysis, the uncertain parameters.

In an embodiment, the performing the nanoindentation uniaxial compression finite element numerical simulation in the finite element simulation software on the models of the cemented carbide specimen under different pressure conditions to obtain simulated values under different pressure conditions includes:

performing the nanoindentation uniaxial compression finite element numerical simulation with multiple pressure values incremented by 20 millinewtons (mN).

In an embodiment, the multiple pressure values incremented by 20 mN are 50 mN, 70 mN, 90 mN, 110 mN, 130 mN, 150 mN, 170 mN, 190 mN, and 210 mN.

In an embodiment, a mesh size used in finite element simulation is less than a size threshold, and the size threshold ranges from 0.3 to 0.7 micrometers (μm).

In an embodiment, each of the Mooney-Rivlin model, the cohesive force model, the models of the cemented carbide specimen, and the micro-pillar models is software configured to be stored in at least one memory and executable by at least one processor coupled to the at least one memory.

The technical solutions provided by the embodiments of the disclosure have the following beneficial effects.

In the disclosed embodiments, the method for determining fracture toughness is provided. In the method, the Mooney-Rivlin model and the cohesive force model are used in combination in the finite element simulation software to describe the characteristics of the cemented carbide specimen. The Mooney-Rivlin model can more accurately describe the characteristics of the cemented carbide specimen compared to the cohesive force model. After crack formation, the cohesive force model is used to calculate the fracture toughness (fracture energy), thereby improving the calculation accuracy. After the fracture toughness is calculated, the mode I fracture energy and the mode II fracture energy are imported into the cohesive force model. Subsequently, the nanoindentation uniaxial compression finite element numerical simulation is performed in the finite element simulation software, and the nanoindentation experiment is performed on the cemented carbide specimen to verify whether the calculated fracture toughness meets the required accuracy. If the requirements are not met, the parameters are adjusted, and the fracture toughness is recalculated to further improve the accuracy of the fracture toughness calculation.

### BRIEF DESCRIPTION OF DRAWINGS

To more clearly illustrate the technical solutions in the disclosure or the prior art, the accompanying drawings required for the description of the embodiments or the related art will be briefly introduced below. It is apparent that the drawings described hereinafter are some embodiments of the disclosure. For those skilled in the art, without exerting creative effort, other drawings can also be obtained based on these accompanying drawings.

FIG. 1 illustrates a flowchart diagram of a method for determining fracture toughness of cemented carbide according to an embodiment of the disclosure.

FIG. 2 illustrates a schematic diagram of a plastic tensile specimen according to the embodiment of the disclosure.

FIG. 3 illustrates a schematic tensile diagram of a cemented carbide specimen according to the embodiment of the disclosure.

FIG. 4 illustrates a schematic diagram of the cemented carbide specimen during an indentation experiment according to the embodiment of the disclosure.

Description of reference signs: 1: plastic tensile specimen; 2: cemented carbide specimen; 3: nano-indenter.

### DETAILED DESCRIPTION OF EMBODIMENTS

To make the objectives, technical solutions, and advantages of the disclosure clearer, the technical solutions of the disclosure will be described in detail below in conjunction with the accompanying drawings. It is apparent that the described embodiments are only a portion of the embodiments of the disclosure, not all of them. Based on the embodiments of the disclosure, all other embodiments obtained by those skilled in the art without creative effort fall within the scope of protection of the disclosure.

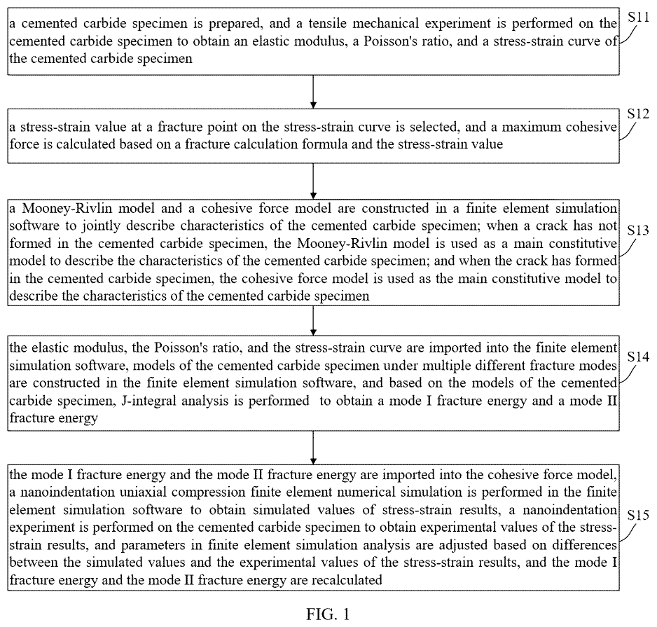

FIG. 1 illustrates a flowchart diagram of a method for determining fracture toughness of cemented carbide according to an embodiment of the disclosure. Referring to FIG. 1, the method includes the following steps.

S11, a cemented carbide specimen is prepared, and a tensile mechanical experiment is performed on the cemented carbide specimen to obtain an elastic modulus, a Poisson's ratio, and a stress-strain curve of the cemented carbide specimen.

In step S11, a cemented carbide coating (i.e., the cemented carbide specimen) is prepared on a plastic tensile specimen. After the coating is applied, the plastic substrate is melted under high-temperature conditions, and the cemented carbide coating tensile specimen is retained. Tensile mechanical tests are then conducted in the laboratory to obtain the elastic modulus, the Poisson's ratio, and the stress-strain curve of the cemented carbide coating.

The dimensions of the cemented carbide specimen comply with the specifications outlined in the national standard GB/T 228.1-2021 (Metallic materials—Tensile testing—Part 1: Method of test at room temperature).

S12, a stress-strain value at a fracture point on the stress-strain curve is selected, and a maximum cohesive force is calculated based on a fracture calculation formula and the stress-strain value.

In an embodiment, step S12 includes the following steps:
calculating the maximum cohesive force Tₘₐₓ using the fracture calculation formula

$$t = \{ \begin{matrix}K δ , & δ ⩽ {δ}_{c} \\ {T}_{max} , & δ > {δ}_{c}\end{matrix} ,$$

where t represents a cohesive force, K represents a cohesive force stiffness, δ represents a crack tip opening displacement, and δ_{c} represents a critical displacement; and
dividing, during calculation of the maximum cohesive force, the cohesive force into a normal stress value σ and a shear stress value τ through control equations as follows:

$$σ = \{ \begin{matrix}\frac{{σ}_{max}}{{δ}_{n}^{0}} δ & δ ⩽ {δ}_{n}^{0} \\ {σ}_{max} \frac{{δ}_{n}^{f} - δ}{{δ}_{n}^{f} - {δ}_{n}^{0}} & δ > {δ}_{n}^{0}\end{matrix} ,$$

$$τ = \{ \begin{matrix}\frac{{τ}_{max}}{{δ}_{t}^{0}} δ & δ ⩽ {δ}_{t}^{0} \\ {τ}_{max} \frac{{δ}_{t}^{f} - δ}{{δ}_{t}^{f} - {δ}_{t}^{0}} & δ > {δ}_{t}^{0}\end{matrix} ;$$

where σₘₐₓ represents a maximum normal stress value, and

$${δ}_{n}^{0}$$

interface opening displacement value corresponding to the maximum normal stress value; τₘₐₓ represents a maximum shear stress value, and

$${δ}_{t}^{0}$$

represents a crack interface opening displacement value corresponding to the maximum shear stress value, and

$${δ}_{n}^{f}$$

represents a crack interface opening displacement value corresponding to a stress value exceeding σₘₐₓ, and

$${δ}_{t}^{f}$$

represents a crack interface opening displacement value corresponding to a stress value exceeding τₘₐₓ.

In the embodiment, when calculating the maximum cohesive force, the cohesive force is divided into a normal stress and a shear stress, thereby further enhancing the accuracy of the maximum cohesive force calculation.

In the embodiment, the calculation process employs a bilinear traction-separation law, simplifying the micro-pillar fracture behavior into two linear stages: one is the elastic stage before reaching the yield point, during which the deformation of the material is reversible, meaning that the material can return to its original state after the external force is removed; the other is the plastic stage after reaching the yield point, during which the material undergoes permanent deformation, and the deformation cannot be fully recovered even after the external force is removed.

S13, a Mooney-Rivlin model and a cohesive force model are constructed in a finite element simulation software to jointly describe characteristics of the cemented carbide specimen; when a crack has not formed in the cemented carbide specimen, the Mooney-Rivlin model is used as a main constitutive model to describe the characteristics of the cemented carbide specimen; and when the crack has formed in the cemented carbide specimen, the cohesive force model is used as the main constitutive model to describe the characteristics of the cemented carbide specimen.

In an embodiment, step S13 includes:
when the crack has not formed in the cemented carbide specimen, using the Mooney-Rivlin model as the main constitutive model for calculating the characteristics of the cemented carbide specimen, and describing a material stress-strain relationship through a strain energy density function:

$$W = {C}_{10} ( {I}_{1} - 3 ) + {C}_{01} ( {I}_{2} - 3 ) + \frac{1}{d} {( J - 1 )}^{2} ;$$

when the crack has formed in the cemented carbide specimen, using the cohesive force model as the main constitutive model for calculating the characteristics of the cemented carbide specimen, including: assuming that there is a cohesive force zone at an interface of the crack or a crack tip of the crack, where a material stress-strain relationship in the cohesive force zone is different from that in other regions; defining a constitutive relationship and a damage evolution law of the cohesive force zone; and simulating debonding of the interface and propagation of the crack.

In the embodiment, the Mooney-Rivlin model and the cohesive force model are employed to jointly describe the material stress-strain relationship. The Mooney-Rivlin model characterizes the material stress-strain relationship through a strain energy density function, which, compared to the cohesive force model, is advantageous for enhancing the accuracy of the subsequent fracture toughness calculation.

S14, the elastic modulus, the Poisson's ratio, and the stress-strain curve are imported into the finite element simulation software, models of the cemented carbide specimen under multiple different fracture modes are constructed in the finite element simulation software, and based on the models of the cemented carbide specimen, J-integral analysis is performed to obtain a mode I fracture energy and a mode II fracture energy.

In an embodiment, step S14 includes the following first to fourth steps.

A first step, micro-pillar models of the cemented carbide specimen for an opening mode, a sliding mode and a tearing mode are constructed based on linear elastic fracture mechanics, and stress-strain results for opening-mode fracture, in-plane shear fracture, and transverse shear fracture are calculated by using the micro-pillar models, respectively.

The micro-pillar models of the cemented carbide specimen for the opening mode, the sliding mode and the tearing mode are constructed by using the cohesive force model.

In the embodiment, the dimension of each micro-pillar model is 8 μm×20 μm.

A second step, stress angular variations for the micro-pillar models of the cemented carbide specimen for the opening mode, the sliding mode and the tearing mode are determined according to the stress-strain results for the opening-mode fracture, the in-plane shear fracture and the transverse shear fracture.

A third step, the stress angular variations for the micro-pillar models of the cemented carbide specimen for the opening mode, the sliding mode and the tearing mode are imported into a partial derivative equation of crack tip asymptotic solution to obtain a relationship among stress, angle and a distance from an integration point to the crack tip.

The partial derivative equation of crack tip asymptotic solution is as follows:

$${σ}_{ij} ( r , θ ) = \frac{{K}_{I}}{\sqrt{2 π r}} {f}_{ij}^{I} ( θ ) + \frac{{K}_{II}}{\sqrt{2 π r}} {f}_{ij}^{II} ( θ ) + \frac{{K}_{III}}{\sqrt{2 π r}} {f}_{ij}^{III} ( θ )$$

where r represents the distance from the integration point to the crack tip, θ=arctan (x₂/x₁), θ represents the polar angle in polar coordinates, x₁ represents the coordinate component along one axis (such as the x-axis) in a Cartesian coordinate system, and x₂ represents the coordinate component along the other axis (such as the y-axis) that is perpendicular to x₁ in the Cartesian coordinate system; K/represents a mode I (opening) stress intensity factor, K_{II} represents a mode II (in-plane shear) stress intensity factor, K_{III} represents the mode III (transverse shear) stress intensity factor. fᵢⱼ represents the angular variation of stress for different fracture modes, obtained from the finite element simulation.

A fourth step, based on the relationship among the stress, the angle and the distance from the integration point to the crack tip, the J-integral analysis is performed to obtain the mode I fracture energy and the mode II fracture energy.

The definition of the J-integral is as follows:

$$J = {\int }_{Γ} ( wdy - T \cdot \frac{\partial u}{\partial x} ds )$$

where w represents the strain energy density, T represents the traction vector on the crack boundary, u represents the displacement vector, and ds represents the path differential element.

During the finite element analysis process, the J-integral value for the entire path can be obtained by integrating over each element along the integration path and then summing up the results. Utilizing post-processing capabilities of the finite element simulation software, stress, strain, and displacement data at each node along the path can be extracted to calculate the integral to obtain the energy required for the crack to propagate over a unit area, thereby determining the required J_{c1} (the mode I fracture energy) and J_{c2} (the mode II fracture energy).

S15, the mode I fracture energy and the mode II fracture energy are imported into the cohesive force model, a nanoindentation uniaxial compression finite element numerical simulation is performed in the finite element simulation software to obtain simulated values of stress-strain results, a nanoindentation experiment is performed on the cemented carbide specimen to obtain experimental values of the stress-strain results, and parameters in finite element simulation analysis are adjusted based on differences between the simulated values and the experimental values of the stress-strain results, and the mode I fracture energy and the mode II fracture energy are recalculated.

In an embodiment, step S15 includes the following steps 1-4.

Step 1, the mode I fracture energy and the mode II fracture energy are imported into the cohesive force model in the finite element simulation software.

Step 2, the nanoindentation uniaxial compression finite element numerical simulation in the finite element simulation software is performed on the models of the cemented carbide specimen to obtain the simulated values of the stress-strain results, the nanoindentation experiment is performed on the cemented carbide specimen to obtain the experimental values of the stress-strain results, and a mesh size and a mesh number in the finite element simulation software are adjusted based on magnitudes of the simulated values and the experimental values of the stress-strain results.

In an embodiment, step 2 includes:
reducing the mesh size and decreasing the number of meshes when computation time is too long; refining a mesh in a fracture part, reducing the mesh size and increasing the mesh number when accuracy of simulation results is low.

During the fracture simulation process, since the fracture simulation is conducted by pre-setting a crack, it leads to stress concentration at the crack tip. When the mesh approaches the crack tip, there is a significant stress-strain gradient. It is necessary to refine the finite element mesh near the crack tip. The nanoindentation uniaxial compression finite element numerical simulation is performed by using the finite element simulation model for the cemented carbide coating. The numerical simulation results are compared with experimental results to fit and match, and the accuracy of the finite element data simulation results is assessed for optimization to determine the best mesh size and number. When the computation time is too long, the mesh size and number are reduced. When the accuracy of the simulation results is low, the meshes are refined around the fracture area by decreasing the mesh size and increasing the mesh number.

Step 3, the nanoindentation uniaxial compression finite element numerical simulation in the finite element simulation software is performed on the models of the cemented carbide specimen under different pressure conditions to obtain simulated values under different pressure conditions, the nanoindentation experiment is performed on the cemented carbide specimen to obtain the experimental values of the stress-strain results, and uncertain parameters in the finite element simulation analysis are adjusted based on differences between the simulated values under different pressure conditions and the experimental values of the stress-strain results.

In an embodiment, step 3 includes the following first to second steps.

A first step, when an error between the simulated values under different pressure conditions and the experimental values of the stress-strain results exceeds a threshold, uncertainty parameter impact analysis is performed on the uncertain parameters in the finite element simulation to assess impact weights of the uncertain parameters on calculation results of the fracture toughness, where the uncertain parameters include material parameters of the cemented carbide specimen, geometric parameters of the cemented carbide specimen, and loading conditions in the finite element simulation software.

In the embodiment, the nanoindentation uniaxial compression finite element numerical simulation is performed with multiple pressure values incremented by 20 mN. Using an increment of 20 mN ensures the accuracy of the nanoindentation uniaxial compression finite element numerical simulations.

In the embodiment, the multiple pressure values incremented by 20 mN are 50 mN, 70 mN, 90 mN, 110 mN, 130 mN, 150 mN, 170 mN, 190 mN, and 210 mN.

A second step, the uncertain parameters are adjusted based on results of the uncertainty parameter impact analysis.

In the embodiment, the impact weight of the uncertain parameters on the calculation results of the fracture toughness is assessed through the uncertainty parameter impact analysis, thereby adjusting the uncertain parameters to further enhance the accuracy of fracture toughness calculation.

A nano-indenter is used to conduct the nanoindentation experiment under different pressures and corresponding finite element numerical simulation. The simulated values are compared with the experimental values to verify the effectiveness of the determination method. When the error between the simulated stress-strain results and the experimental stress-strain values exceeds 5%, uncertain factors in the finite element simulation calculation process are altered, such as: material parameter uncertainties (corrections are made to account for thermal effects, variations in elemental composition, and the influence of coating microstructure on mechanical properties during the processing of hard alloy coatings); geometric shape errors (surface defects that exist during the coating preparation process, and corrections are made to the finite element calculation simulation model based on the actual prepared micro-pillar morphology); and variations in loading conditions (since there are some errors in the mechanical loading during the actual loading process, corrections and adjustments are made to the boundary conditions of the finite element simulation based on the actual loading process, including the magnitude and rate of loading). The uncertainty parameter impact analysis is then conducted to assess the impact weight of these factors on the calculation results of the fracture toughness of the cemented carbide coating, further improving the reliability and accuracy of the method provided by the disclosure.

In the embodiment, the mesh size used in finite element simulation is less than a size threshold, and the size threshold ranges from 0.3 to 0.7 μm. For example, the size threshold is 0.5 μm.

In the embodiment, using meshes of the above mesh size helps to ensure both computational accuracy and speed.

Step 4, the mode I fracture energy and the mode II fracture energy are recalculated.

In the embodiment, the method for determining fracture toughness is provided. The method involves using both the Mooney-Rivlin model and the cohesive force model in the finite element simulation software to describe the characteristics of the cemented carbide specimen. The Mooney-Rivlin model, compared to the cohesive force model, offers a more precise description of the characteristics of the cemented carbide specimen. After crack formation, the cohesive force model is employed to calculate the fracture toughness (fracture energy), thereby enhancing the computational accuracy. Furthermore, after obtaining the fracture toughness, the mode I fracture energy and mode II fracture energy are imported into the cohesive force model. Subsequently, the nanoindentation uniaxial compression finite element numerical simulation is conducted in the finite element simulation software, along with nanoindentation experiment on the cemented carbide specimen, to verify whether the calculated fracture toughness meets the required precision. If the requirements are not met, parameters are adjusted, and the fracture toughness is recalculated to further improve the computational accuracy of the fracture toughness.

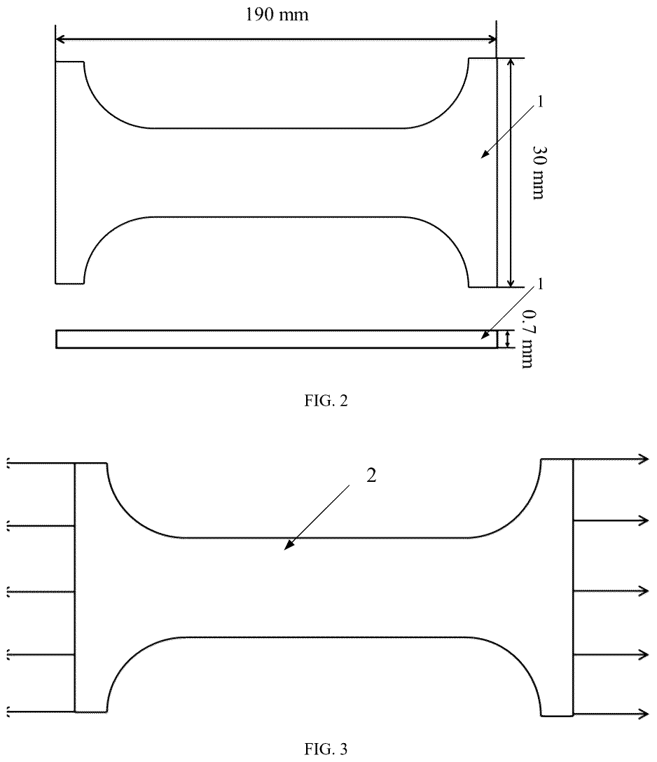

FIG. 2 illustrates a schematic diagram of a plastic tensile specimen according to the embodiment of the disclosure. As shown in FIG. 2, FIG. 2 shows the length, width, and thickness of the plastic tensile specimen 1. The length is 190 mm, the width is 30 mm, and the thickness is 0.7 mm. The cemented carbide specimen is prepared on the plastic tensile specimen 1.

The dimensions mentioned above serve only as an example provided in this disclosure and are not intended to limit the scope of this disclosure.

FIG. 3 illustrates a schematic tensile diagram of the cemented carbide specimen according to the embodiment of the disclosure. FIG. 3 shows the direction of the applied force during the tensile test, with the arrow indicating the direction of the force applied to the cemented carbide specimen 2.

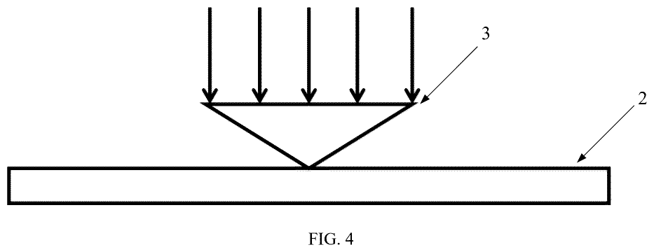

FIG. 4 illustrates a schematic diagram of the cemented carbide specimen during an indentation experiment according to the embodiment of the disclosure. As shown in FIG. 4, pressure is applied to the cemented carbide specimen 2 by a nano-indenter 3, with the direction of the arrow indicating the direction of the applied pressure.

Finally, it should be noted that the above embodiments are only used to illustrate the technical solution of the disclosure, and not to limit it; Although the disclosure has been described in detail with reference to the aforementioned embodiments, those skilled in the art should understand that they can still modify the technical solutions described in the aforementioned embodiments, or equivalently replace some of the technical features; And these modifications or substitutions do not depart from the essence and scope of the corresponding technical solutions of the embodiments of the disclosure.

What is claimed is:

1. A method for determining fracture toughness of cemented carbide, comprising:
preparing a cemented carbide specimen, and performing a tensile mechanical experiment on the cemented carbide specimen to obtain an elastic modulus, a Poisson's ratio, and a stress-strain curve of the cemented carbide specimen;
selecting a stress-strain value at a fracture point on the stress-strain curve, and calculating, based on a fracture calculation formula and the stress-strain value, a maximum cohesive force;
constructing a Mooney-Rivlin model and a cohesive force model in a finite element simulation software to jointly describe characteristics of the cemented carbide specimen; using, when a crack has not formed in the cemented carbide specimen, the Mooney-Rivlin model as a main constitutive model to describe the characteristics of the cemented carbide specimen; and using, when the crack has formed in the cemented carbide specimen, the cohesive force model as the main constitutive model to describe the characteristics of the cemented carbide specimen;
importing the elastic modulus, the Poisson's ratio, and the stress-strain curve into the finite element simulation software, constructing models of the cemented carbide specimen under a plurality of different fracture modes in the finite element simulation software, and performing, based on the models of the cemented carbide specimen, J-integral analysis to obtain a mode I fracture energy and a mode II fracture energy; and
importing the mode I fracture energy and the mode II fracture energy into the cohesive force model, performing a nanoindentation uniaxial compression finite element numerical simulation in the finite element simulation software to obtain simulated values of stress-strain results, performing a nanoindentation experiment on the cemented carbide specimen to obtain experimental values of the stress-strain results, and adjusting parameters in finite element simulation analysis based on differences between the simulated values and the experimental values of the stress-strain results, and recalculating the mode I fracture energy and the mode II fracture energy.

2. The method for determining fracture toughness of cemented carbide as claimed in claim 1, wherein the calculating, based on a fracture calculation formula and the stress-strain value, a maximum cohesive force comprises:
calculating the maximum cohesive force Tₘₐₓ using the fracture calculation formula
$$t = \{ \begin{matrix}K δ , & δ ⩽ {δ}_{c} \\ {T}_{max} , & δ > {δ}_{c}\end{matrix} ,$$
where t represents a cohesive force, K represents a cohesive force stiffness, δ represents a crack tip opening displacement, and δ_{c} represents a critical displacement; and
dividing, during calculation of the maximum cohesive force, the cohesive force into a normal stress value σ and a shear stress value τ through control equations as follows:
$$σ = \{ \begin{matrix}\frac{{σ}_{max}}{{δ}_{n}^{0}} δ & δ ⩽ {δ}_{n}^{0} \\ {σ}_{max} \frac{{δ}_{n}^{f} - δ}{{δ}_{n}^{f} - {δ}_{n}^{0}} & δ > {δ}_{n}^{0}\end{matrix} ,$$
$$τ = \{ \begin{matrix}\frac{{τ}_{max}}{{δ}_{t}^{0}} δ & δ ⩽ {δ}_{t}^{0} \\ {τ}_{max} \frac{{δ}_{t}^{f} - δ}{{δ}_{t}^{f} - {δ}_{t}^{0}} & δ > {δ}_{t}^{0}\end{matrix} ;$$
where σₘₐₓ represents a maximum normal stress value, and
$${δ}_{n}^{0}$$
represents a crack interface opening displacement value corresponding to the maximum normal stress value; τₘₐₓ represents a maximum shear stress value, and
$${δ}_{t}^{0}$$
represents a crack interface opening displacement value corresponding to the maximum shear stress value; and
$${δ}_{n}^{f}$$
represents a crack interface opening displacement value corresponding to a stress value exceeding σₘₐₓ, and
$${δ}_{t}^{f}$$
represents a crack interface opening displacement value corresponding to a stress value exceeding τₘₐₓ.

3. The method for determining fracture toughness of cemented carbide as claimed in claim 1, wherein the constructing a Mooney-Rivlin model and a cohesive force model in a finite element simulation software to jointly describe characteristics of the cemented carbide specimen comprises:
when the crack has not formed in the cemented carbide specimen, using the Mooney-Rivlin model as the main constitutive model for calculating the characteristics of the cemented carbide specimen, and describing a material stress-strain relationship through a strain energy density function:
$$W = {C}_{10} ( {I}_{1} - 3 ) + {C}_{01} ( {I}_{2} - 3 ) + \frac{1}{d} {( J - 1 )}^{2} ;$$
when the crack has formed in the cemented carbide specimen, using the cohesive force model as the main constitutive model for calculating the characteristics of the cemented carbide specimen, comprising: assuming that there is a cohesive force zone at an interface of the crack or a crack tip of the crack, wherein a material stress-strain relationship in the cohesive force zone is different from that in other regions; defining a constitutive relationship and a damage evolution law of the cohesive force zone; and simulating debonding of the interface and propagation of the crack.

4. The method for determining fracture toughness of cemented carbide as claimed in claim 1, wherein the importing the elastic modulus, the Poisson's ratio, and the stress-strain curve into the finite element simulation software, constructing models of the cemented carbide specimen under a plurality of different fracture modes in the finite element simulation software, and performing, based on the models of the cemented carbide specimen, J-integral analysis to obtain a mode I fracture energy and a mode II fracture energy comprises:
constructing, based on linear elastic fracture mechanics, micro-pillar models of the cemented carbide specimen for an opening mode, a sliding mode and a tearing mode, and calculating stress-strain results for opening-mode fracture, in-plane shear fracture, and transverse shear fracture by using the micro-pillar models, respectively;
determining, according to the stress-strain results for the opening-mode fracture, the in-plane shear fracture and the transverse shear fracture, stress angular variations for the micro-pillar models of the cemented carbide specimen for the opening mode, the sliding mode and the tearing mode;
importing the stress angular variations for the micro-pillar models of the cemented carbide specimen for the opening mode, the sliding mode and the tearing mode into a partial derivative equation of crack tip asymptotic solution to obtain a relationship among stress, angle and a distance from an integration point to a crack tip of the crack; and
performing, based on the relationship among the stress, the angle and the distance from the integration point to the crack tip, the J-integral analysis to obtain the mode I fracture energy and the mode II fracture energy.

5. The method for determining fracture toughness of cemented carbide as claimed in claim 1, wherein the performing a nanoindentation uniaxial compression finite element numerical simulation in the finite element simulation software to obtain simulated values of stress-strain results, performing a nanoindentation experiment on the cemented carbide specimen to obtain experimental values of the stress-strain results, and adjusting parameters in finite element simulation based on differences between the simulated values and the experimental values of the stress-strain results, and recalculating the mode I fracture energy and the mode II fracture energy comprises:
importing the mode I fracture energy and the mode II fracture energy into the cohesive force model in the finite element simulation software;
performing the nanoindentation uniaxial compression finite element numerical simulation in the finite element simulation software on the models of the cemented carbide specimen to obtain the simulated values of the stress-strain results, performing the nanoindentation experiment on the cemented carbide specimen to obtain the experimental values of the stress-strain results, and adjusting, based on magnitudes of the simulated values and the experimental values of the stress-strain results, a mesh size and a mesh number in the finite element simulation software;
performing the nanoindentation uniaxial compression finite element numerical simulation in the finite element simulation software on the models of the cemented carbide specimen under different pressure conditions to obtain simulated values under different pressure conditions, performing the nanoindentation experiment on the cemented carbide specimen to obtain the experimental values of the stress-strain results, and adjusting uncertain parameters in the finite element simulation analysis based on differences between the simulated values under different pressure conditions and the experimental values of the stress-strain results; and
recalculating the mode I fracture energy and the mode II fracture energy.

6. The method for determining fracture toughness of cemented carbide as claimed in claim 5, wherein the performing the nanoindentation uniaxial compression finite element numerical simulation in the finite element simulation software on the models of the cemented carbide specimen to obtain the simulated values of the stress-strain results, performing the nanoindentation experiment on the cemented carbide specimen to obtain the experimental values of the stress-strain results, and adjusting, based on magnitudes of the simulated values and the experimental values of the stress-strain results, a mesh size and a mesh number in the finite element simulation software comprises:
reducing the mesh size and decreasing the number of meshes when computation time is too long;
refining a mesh in a fracture part, reducing the mesh size and increasing the mesh number when accuracy of simulation results is low.

7. The method for determining fracture toughness of cemented carbide as claimed in claim 5, wherein the performing the nanoindentation uniaxial compression finite element numerical simulation in the finite element simulation software on the models of the cemented carbide specimen under different pressure conditions to obtain simulated values under different pressure conditions, performing the nanoindentation experiment on the cemented carbide specimen to obtain the experimental values of the stress-strain results, and adjusting uncertain parameters in the finite element simulation based on differences between the simulated values under different pressure conditions and the experimental values of the stress-strain results comprises:
performing, when an error between the simulated values under different pressure conditions and the experimental values of the stress-strain results exceeds a threshold, uncertainty parameter impact analysis on the uncertain parameters in the finite element simulation to assess impact weights of the uncertain parameters on calculation results of the fracture toughness, wherein the uncertain parameters comprise material parameters of the cemented carbide specimen, geometric parameters of the cemented carbide specimen, and loading conditions in the finite element simulation software; and adjusting, based on results of the uncertainty parameter impact analysis, the uncertain parameters.

8. The method for determining fracture toughness of cemented carbide as claimed in claim 6, wherein the performing the nanoindentation uniaxial compression finite element numerical simulation in the finite element simulation software on the models of the cemented carbide specimen under different pressure conditions to obtain simulated values under different pressure conditions comprises:
performing the nanoindentation uniaxial compression finite element numerical simulation with multiple pressure values incremented by 20 millinewtons (mN).

9. The method for determining fracture toughness of cemented carbide as claimed in claim 8, wherein the multiple pressure values incremented by 20 mN are 50 mN, 70 mN, 90 mN, 110 mN, 130 mN, 150 mN, 170 mN, 190 mN, and 210 mN.

10. The method for determining fracture toughness of cemented carbide as claimed in claim 1, wherein a mesh size used in finite element simulation is less than a size threshold, and the size threshold ranges from 0.3 to 0.7 micrometers (μm).
